(19) United States
(12) Patent Application Publication
(10) Pub. No.: US 2007/0062317 A1
(43) Pub. Date: Mar. 22, 2007

(54) Electric Cylinder

(75) Inventors: Shigekazu Nagai, Tsukubamirai-shi, Ibaraki-ken (JP); Ryuichi Masui, Tsukubamirai-shi, Ibaraki-ken (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC KABUSHIKI KAISHA, Tokyo (JP)

(21) Appl. No.: 11/530,500

(22) Filed: Sep. 11, 2006

(30) Foreign Application Priority Data
Sep. 21, 2005 (JP) 2005-273015

(51) Int. Cl. F16H 27/02; F16H 29/02

(52) U.S. Cl. 74/89; 251/304

(57) ABSTRACT

A driving force is transmitted from a driving section to a cylinder mechanism having a piston while subjected to speed reduction. Further, an operation oil is charged into a rotary housing of a power transmission switching mechanism that is arranged between the driving section and the cylinder mechanism. First plates and second plates are alternately arranged along an inner shaft, the first plates being connected on a side of the driving section, and the second plates being connected on a side of the cylinder mechanism.

### BACKGROUND OF THE INVENTION

1. Field of the Invention

The present invention relates to an electric cylinder, in which a driving force is transmitted to a cylinder mechanism from a driving section via a speed reducing mechanism, in order to displace a piston in the cylinder mechanism.

2. Description of the Related Art

In a known type of electric cylinder, the electric cylinder is integrally provided with a driving source composed of, for example, an electric motor, a speed reducing mechanism provided in a main body case connected to the driving source, and which has a gear for transmitting a driving force from the driving source, and a cylinder section connected to the main body case, wherein the driving force is transmitted to the cylinder section from the speed reducing mechanism.

Such an electric cylinder is disclosed, for example, in Japanese Laid-Open Patent Publication No. 2002-213574, and includes an electric unit that supplies a rotary driving force, together with a gear speed reducing mechanism for transmitting rotation of the electric unit to an output shaft, while reducing the speed of rotation. The rotary driving force of the electric unit is subjected to a predetermined speed reduction as a result of transmission via the gear speed reducing mechanism, which includes a plurality of gears meshed with each other. The rotary driving force is output externally via an output shaft, which is arranged substantially in parallel with the electric unit.

On the other hand, an electric cylinder is disclosed in Japanese Laid-Open Patent Publication No. 10-127008, which comprises an electric motor, a cylinder section arranged substantially in parallel with an axis of the electric motor, and a speed reducing mechanism that is connected between the electric motor and the cylinder section. A driving force of the electric motor is transmitted to a screw lever of the cylinder section, via a pinion gear installed on a drive shaft of the electric motor and a flat gear meshed with the pinion gear. The screw lever is rotated, and thus a piston in threaded engagement with the screw lever is displaced in an axial direction.

In the aforementioned conventional techniques of Japanese Laid-Open Patent Publication Nos. 2002-213574 and 10-127008, an electric unit (electric motor), which is driven under action of applied electric power, is adopted as the driving source. Therefore, a driving force is output from the electric unit, to an output shaft or to a cylinder section, under a driving action of the driving source. However, in general, when using such a driving source, an inertial force is generated, which causes continuous rotation for a predetermined period of time, even after application of electricity has been stopped. Therefore, it is difficult to immediately halt such rotary driving. For this reason, an inertial force of the driving source is transmitted to the cylinder section as a rotary driving force, via a speed reducing mechanism, even after stopping the electric cylinder. As a result, excessive loads are generated by the rotary driving force, with respect to the speed reducing mechanism and the cylinder section. Further, the cylinder section may consequently be displaced by an amount somewhat larger than the desired displacement amount (displacement position).

When the driving source is continuously rotated a predetermined amount by inertial force, after reaching the displacement terminal end position at which displacement of the cylinder section is stopped, the gear of the speed reducing mechanism that is connected to the cylinder section stops being rotated, while the gear connected to the driving source continues to be rotated. Therefore, a load is generated between both respective gears, which are meshed with each other. Consequently, durability of the speed reducing mechanism is lowered.

### SUMMARY OF THE INVENTION

A general object of the present invention is to provide an electric cylinder, in which durability thereof is improved by mitigating loads imposed on the driving section, the cylinder mechanism and the speed reducing mechanism.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an overall perspective view illustrating an electric cylinder according to an embodiment of the present invention;

FIG. 2 is an overall longitudinal sectional view illustrating the electric cylinder shown in FIG. 1;

FIG. 3 is, with partial omission, a magnified perspective view illustrating a gear unit of the electric cylinder shown in FIG. 1, as viewed from a different direction;

FIG. 4 is a magnified longitudinal sectional view illustrating elements disposed in the vicinity of a power transmission switching mechanism of the electric cylinder shown in FIG. 2;

FIG. 5 is an exploded perspective view illustrating the power transmission switching mechanism of the electric cylinder shown in FIG. 1;

FIG. 6 is a vertical sectional view illustrating a state in which a first plate is inserted into an installation hole of a rotary housing, in relation to the elements shown in FIG. 4; and

FIG. 7 is a vertical sectional view illustrating a state in which a second plate is inserted into the installation hole of the rotary housing, in relation to the elements shown in FIG. 4.

### DESCRIPTION OF THE PREFERRED EMBODIMENTS

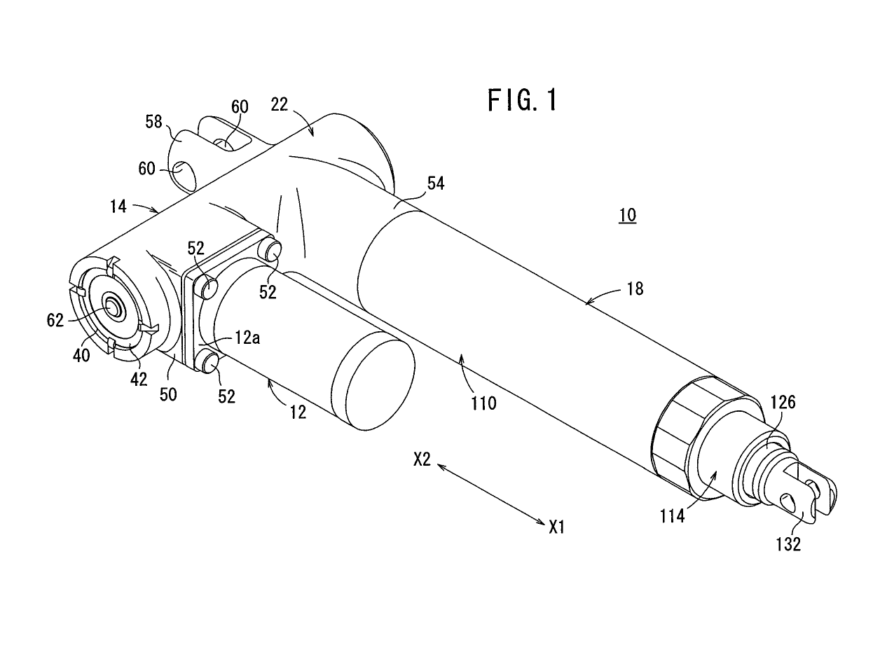

With reference to FIG. 1, reference numeral 10 indicates an electric cylinder according to an embodiment of the present invention.

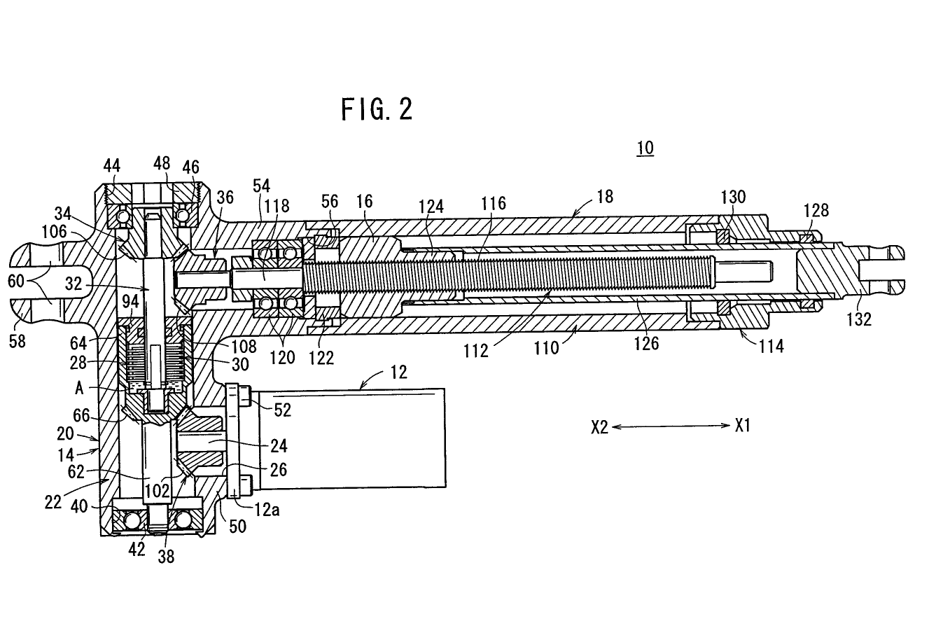

As shown in FIGS. 1 and 2, the electric cylinder 10 comprises a driving section 12, which is driven and rotated by an applied current, a gear unit (speed reducing mechanism) 14 that transmits a driving force from the driving section 12 while reducing the speed thereof, a cylinder mechanism 18 having a piston 16 capable of making stroke displacement by means of the driving force output from the gear unit 14, and a power transmission switching mechanism 20 provided between the driving section 12 and the cylinder mechanism 18, which is capable of transmitting and interrupting the driving force.

The driving section 12 comprises, for example, a DC motor or a stepping motor, which is driven and rotated by current supplied from an unillustrated power source. The driving section 12 is connected to a casing 22 of the gear unit 14 by means of an attachment flange 12a formed at one end thereof. Further, the driving section 12 includes a drive shaft 24, which is inserted into the casing 22 via a first hole 26 provided in the casing 22.

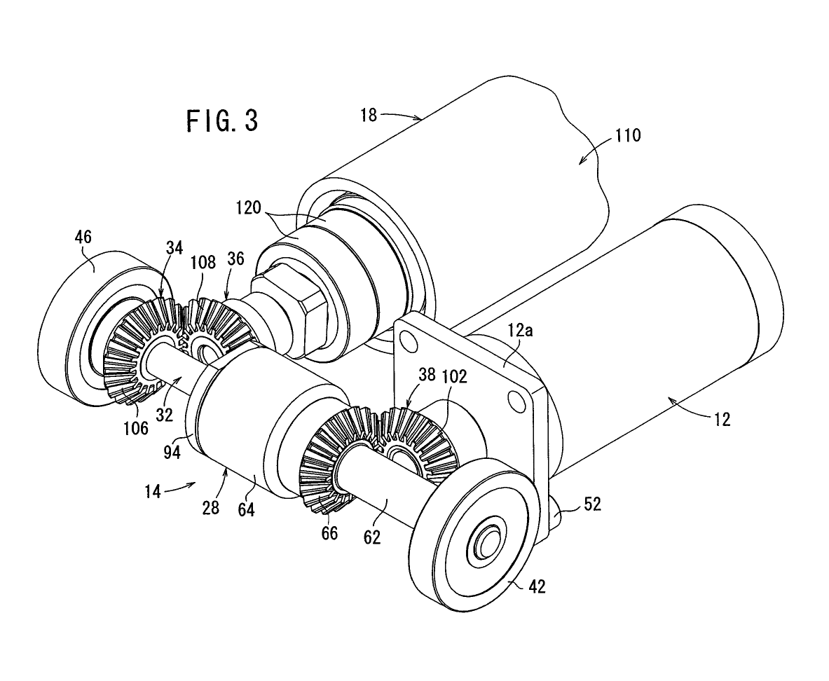

As shown in FIGS. 2 and 3, the gear unit 14 includes the casing 22, which has a cylindrical shape, and a rotary housing (housing) 28 which is rotatably disposed inside the casing 22. The gear unit 14 further includes an inner shaft (shaft) 32, which has one end thereof inserted into the rotary housing 28, and onto which a plurality of plate members 30 are inserted. In addition, the gear unit includes a first gear member 34, which is secured to the other end of the inner shaft 32, a second gear member 36 meshed with the first gear member 34 and secured to a rotary shaft 112 of the cylinder mechanism 18, and a third gear member 38, which is secured to the drive shaft 24 of the driving section 12. Each of the first to third gear members 34, 36, 38, as well as the rotary housing 28, may be formed of, for example, a resin material, a sintered metal, or a light metal material such as aluminum.

As shown in FIG. 2, both ends of the casing 22 are opened toward the outside. A first bearing 42 is installed in a first opening 40 disposed on one end of the casing 22 through an annular groove. A second bearing 46 is installed in a second opening 44 disposed on the other end of the casing 22 through another annular groove. A plug 48 is threaded onto the second opening 44 in order to close the second opening 44.

A first attachment section 50 that protrudes from a side portion of the casing 22 substantially perpendicular to the axis of the casing 22 is formed on one end of the casing 22. The driving section 12 is installed in the first attachment section 50 through a plurality of bolts 52. A first hole 26, which opens to the outside, is formed in an axial direction of the first attachment section 50. The drive shaft 24 of the driving section 12 is inserted into the first hole 26.

On the other hand, a second attachment section 54 that protrudes from the side portion of the casing 22 substantially perpendicular to the axis of the casing 22 is formed on the other end side of the casing 22. The cylinder mechanism 18 is installed on the second attachment section 54. A second hole 56, which opens toward the outside, is formed in the second attachment section 54. A part of the cylinder mechanism 18 is inserted into the second attachment section 54 via the second hole 56. Specifically, the driving section 12 and the cylinder mechanism 18 are each disposed substantially perpendicular to the axis of the casing 22 and substantially in parallel with one another.

A fixed flange 58 is disposed at the other end of the casing 22, so as to be positioned on a side opposite to the second attachment section 54, about the center of axis of the casing 22. The fixed flange 58 protrudes from a side surface of the casing 22, branching into two parts that are separated from each other by a predetermined distance. Through-holes 60, extending in parallel to the axis of the casing 22, are formed respectively in the fixed flange 58.

The electric cylinder 10 can be fixed, for example, to a wall surface through the fixed flange 58.

The rotary housing 28 includes a shaft section 62 supported by the first bearing 42 and arranged on one end of the casing 22, a bottom-equipped cylindrical section 64 having a cylindrical shape formed at the end of the shaft section 62, and a gear-tooth section 66 disposed at the joined portion between the cylindrical section 64 and the shaft section 62, and which has a plurality of teeth engraved on a circumferential surface thereof.

The forward end portion of the shaft section 62, which is disposed on one end of the casing 22, has a reduced diameter. The reduced diameter portion is rotatably supported by the first bearing 42, which is installed in the casing 22.

The cylindrical section 64 is diametrically expanded in a radially outward direction with respect to the shaft section 62. The cylindrical section 64 is disposed in the casing 22 at a position between the first attachment section 50 and the second attachment section 54. An outer circumferential surface of the cylindrical section 64 abuts against an inner circumferential surface of the casing 22, and is guided by the inner circumferential surface when the rotary housing 28 is rotated.

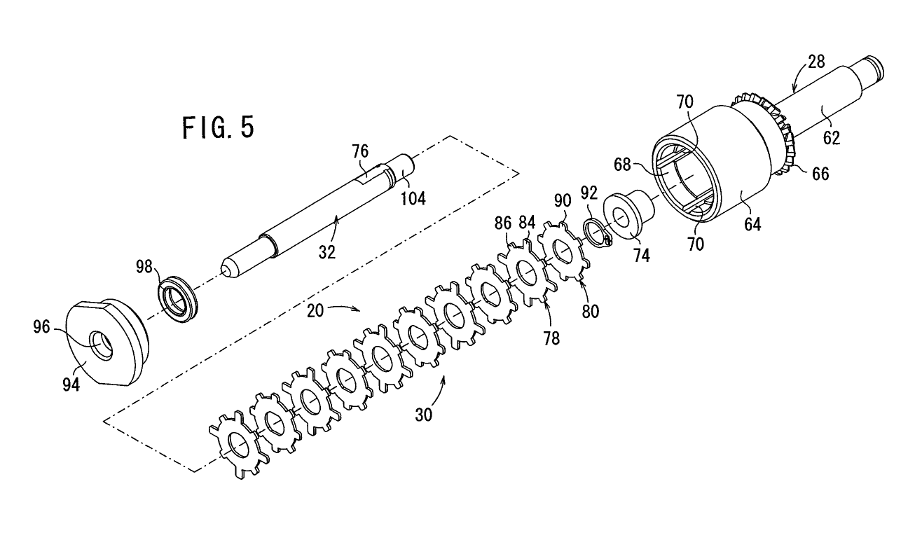

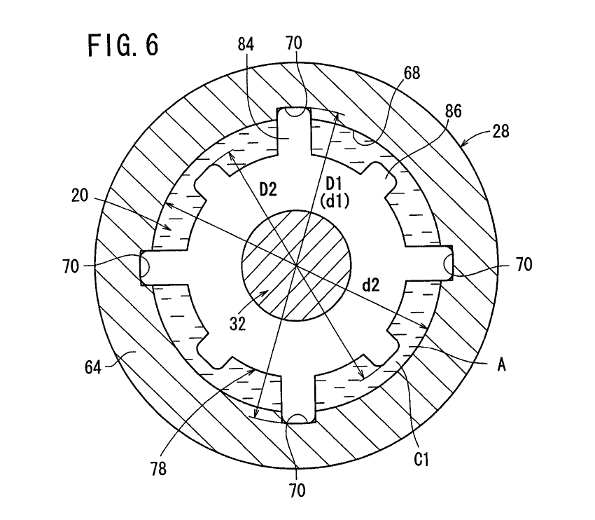

An installation hole 68 is formed in the cylindrical section 64, which opens toward the second opening 44 of the casing 22. The installation hole 68 has a substantially constant diameter. A plurality of grooves 70 (for example, four), which extend in the axial direction, are formed on an inner circumferential surface of the installation hole 68 (see FIGS. 5 to 7). The grooves 70 are recessed in a concave form and have a substantially rectangular cross section. The grooves 70 are separated from each other by predetermined distances in the axial direction of the installation hole 68. In particular, the grooves 70 are separated from each other by 90°, along the inner circumferential surface of the installation hole 68 and about the axial center of the cylindrical section 64 (see FIG. 6).

The power transmission switching mechanism 20 is disposed inside the installation hole 68. The power transmission switching mechanism 20 includes the inner shaft 32, one end of which is inserted into the installation hole 68, the plate member 30, which is composed of a plurality of first and second plates 78, 80, and a lid member 94 that closes the installation hole. A bush 74 installed in a bush hole 72 of the cylindrical section 64 rotatably supports one end of the inner shaft 32.

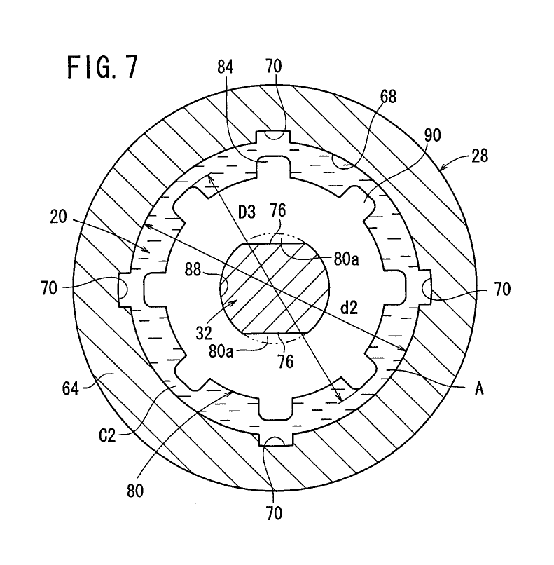

As shown in FIG. 5, a pair of cutout grooves 76 is formed on one end of the inner shaft 32 by cutting the outer circumferential surface thereof in substantially flat shapes. The cutout grooves 76 have a predetermined length from one end toward the other end of the inner shaft 32. Further, the cutout grooves 76 are recessed a slight amount in the radially inward direction, with respect to the outer circumferential surface of the inner shaft 32. The cutout grooves 76 are formed at substantially symmetrical positions in relation to the central axis of the inner shaft 32 (see FIG. 7).

The first plates (first rotary plates) 78 and the second plates (second rotary plates) 80 are inserted onto one end of the inner shaft 32. Each of the first and second plates 78, 80 is formed by a plate member having a substantially constant thickness. The first plates 78 and the second plates 80 are installed and arranged alternately to one another, respectively, on the inner shaft 32.

The first plate 78 has a substantially disk-shaped cross section. As shown in FIG. 6, the first plate 78 has a first shaft hole 82, which is formed in a substantially central portion thereof, and into which the inner shaft 32 is inserted. A plurality of first and second projections 84, 86 (for example, four) protrude radially in radially outward directions from the outer circumferential surface.

The first projections 84 and the second projections 86 are separated from each other by equal angles (for example, 45°), about the center of the first shaft hole 82. The first projections 84 are separated from each other at intervals of 90°, whereas the second projections 86 are formed between the first projections 84. That is, the second projections 86 are separated from each other by intervals of 90° in the same manner as the first projections 84. The first plate 78 has four first projections 84 and four second projections 86, respectively, wherein the second projections 86 are disposed between the first projections 84, so that eight projections are provided in total.

The outer diameter D1 of the first projection 84 is substantially equal to the inner circumferential diameter d1 of the groove 70 of the cylindrical section 64 (D1≈d1). The outer circumferential diameter D2 of the second projection 86 is smaller than the outer circumferential diameter D1 of the first projection 84 (D1>D2). The outer circumferential diameter D2 of the second projection 86 is smaller than the inner circumferential diameter d2 of the installation hole 68 of the cylindrical section 64 (D2<d2).

That is, the first projections 84 protrude a greater amount in the radially outward direction, as compared to the second projections 86. When the first plate 78 is inserted into the installation hole 68 of the cylindrical section 64, the first projections 84 engage within the grooves 70, and a clearance C1 of a predetermined distance is formed between the second projections 86 and the inner circumferential surface of the installation hole 68.

As shown in FIG. 7, the second plate 80 includes a second shaft hole 88 formed at a substantially central portion thereof, having a substantially disk-shaped cross section and a shape that is approximately the same as that of the first plate 78, and into which the inner shaft 32 is inserted. A plurality of third projections 90 (for example, eight) protrude radially, in a radially outward direction, from the outer circumferential surface of the second plate 80.

The second shaft hole 88 is formed as follows. Inner circumferential surface portions of the second shaft hole 88 protrude respectively in opposition to the cutout grooves 76 of the inner shaft 32. The projections 80a engage with the pair of cutout grooves 76 respectively. Accordingly, the inner shaft 32 and the second plates 80 are prevented from making relative displacement with respect to each other in the direction of rotation. Thus, when the inner shaft 32 is rotated and displaced, the second plates 80 are rotated therewith in an integrated manner.

The third projections 90 are separated from each other by equal angles (for example, 45°) about the center of the second shaft hole 88. The number of third projections 90 is the same as the total number (eight) of first and second projections 84, 86 included on the first plate 78. Outer circumferential diameters of the third projections 90 have a substantially identical diameter D3. The outer circumferential diameter D3 of the third projection 90 is substantially equal to the outer circumferential diameter D2 of the second projection 86 (D3≈D2). Therefore, when the second plate 80 is inserted into the installation hole 68, a clearance C2 providing a predetermined distance is formed between the third projections 90 and the inner circumferential surface of the installation hole 68. More specifically, the clearances C1 and C2 are substantially equal to each other, with respect to the installation hole 68, because the outer circumferential diameter D2 of the second projection 86 is substantially equal to the outer circumferential diameter D3 of the third projection 90.

When the first and second plates 78, 80 are inserted onto the inner shaft 32, the first and second projections 84, 86 and the third projections 90 are arranged so that they overlap with each other in the axial direction of the inner shaft 32. The first plate 78, which is arranged on a side nearest to the shaft section 62, is prevented from displacement in the axial direction, by means of a fastening ring 92 that is installed on one end of the inner shaft 32.

Specifically, the first plates 78 engage with the grooves 70 of the cylindrical section 64 and therefore rotate integrally with the rotary housing 28. Further, the second plates 80 engage with the inner shaft 32 and therefore rotate integrally with the inner shaft 32. In other words, the first plates 78 and the second plates 80 are rotated distinctly and separately from each other.

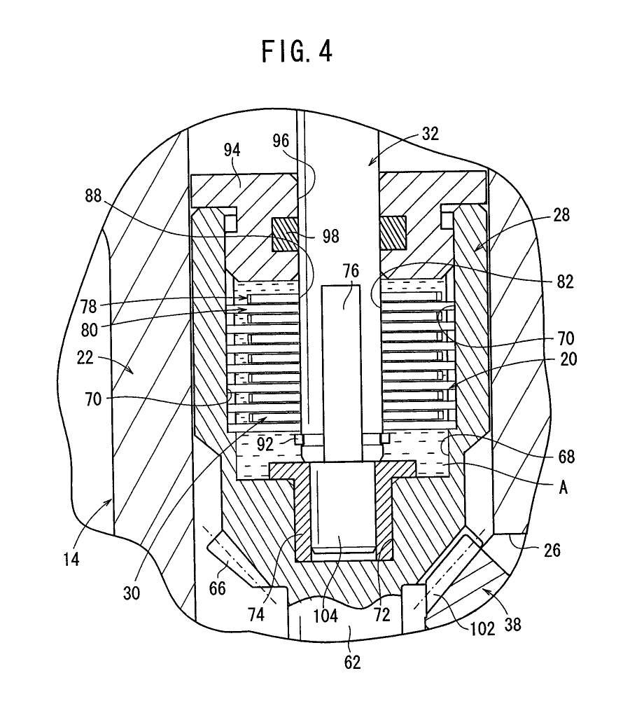

On the other hand, as shown in FIG. 4, while the first and second plates 78, 80 are arranged in the installation hole 68, the cylindrical section 64 is closed by a lid member 94. The inner shaft 32 is inserted into the lid member 94 through a shaft hole 96 that penetrates through a substantially central portion thereof. A seal member 98 is installed in an annular groove in the shaft hole 96. The seal member 98 abuts against the outer circumferential surface of the inner shaft 32, and thus the interior of the installation hole 68 is placed in a tightly (i.e., hermetically) enclosed state.

An operation oil A composed, for example, of silicone oil, is charged into the installation hole 68. An oil having a high viscosity is used as the operation oil A. The viscosity of the operation oil A is appropriately set within a range of, for example, 10,000 to 100,000 cst. The lid member 94 closes the installation hole 68. Therefore, the installation hole 68 functions as an oil storage chamber that is filled with the operation oil A.

The operation oil A is charged into the spaces between the first and second plates 78, 80 that are arranged alternately along the inner shaft 32, resulting in a condition in which the first and second plates 78, 80 are separated from each other by equal distances, with the operation oil A intervening therebetween (see FIG. 4). Specifically, the first and second plates 78, 80 are separated from each other by equal distances along the inner shaft 32.

Teeth 66 are formed on the outer circumferential surface, at the joined portion between the cylindrical section 64 and the shaft section 62. The teeth 66 mesh with the third gear member 38, which is connected to the driving section 12. The teeth 66 are inclined by a predetermined angle (for example, 45°) with respect to the axis of the rotary housing 28. Further, teeth 102 of the third gear member 38 also are formed on the outer circumferential surface, which are inclined by a predetermined angle (for example, 45°) with respect to the axis of the third gear member 38, in the same manner as described above.

That is, the third gear member 38 is driven and rotated under a driving action of the driving section 12, whereby the rotary housing 28 is rotated and displaced by means of the cylindrical section 64, which is meshed with the third gear member 38. Further, the direction of transmission of the rotary driving force is converted to a substantially perpendicular direction, by means of the teeth 66 and 102, which are inclined at predetermined angles with respect to axes of the driving section 12 and the rotary housing 28 respectively.

The cylindrical first gear member 34 is installed on the other end of the inner shaft 32 via a first thin diameter section 104 having a reduced diameter. Teeth 106, which are inclined at a predetermined angle (for example, 45°) with respect to the axis of the first gear member 34, are formed on the outer circumferential surface of the first gear member 34. The teeth 106 are formed on one side of the rotary housing 28, and mesh with teeth 108 of the second gear member 36 installed on the cylinder mechanism 18.

The teeth 106 of the first gear member 34 are mutually opposed to teeth 108 of the second gear member 36. The first gear member 34 is rotatably supported through the second bearing 46 that is installed in the casing 22.

More specifically, the driving force that is transmitted from the driving section 12 to the rotary housing 28 is, in turn, transmitted via the teeth 106, 108, which are inclined at predetermined angles with respect to axes of the rotary housing 28 and the cylinder mechanism 18 respectively. The direction of transmission is converted into a direction that is substantially perpendicular to the axis of the rotary housing 28. In other words, the direction of transmission of the driving force, which is transmitted from the driving section 12, is converted by the gear unit 14 into a substantially perpendicular direction, and the direction of transmission is converted again by the gear unit 14 into a substantially perpendicular direction that is directed to the cylinder mechanism 18.

As shown in FIGS. 1 and 2, the cylinder mechanism 18 includes a cylindrical cylinder tube 110 connected to the casing 22, a rotary shaft 112 supported rotatably inside the cylinder tube 110 and to which a driving force is transmitted from the gear unit 14, and a piston 16, which is threaded onto the rotary shaft 112 and is displaceable in the axial direction.

One end of the cylinder tube 110 is secured to the second attachment section 54 of the casing 22, whereas a cylindrical rod cover 114 is installed on the other end of the cylinder tube 110.

The rotary shaft 112 may be formed, for example, from a resin material, a sintered metal, or a light metal material. The rotary shaft 112 includes a screw section 116 having threads engraved on an outer circumferential surface thereof, and a second thin diameter section 118, which is formed at an end of the screw section 116 and has a reduced diameter, as compared to the screw section 116. The second thin diameter section 118 is inserted into the second hole 56 of the second attachment section 54, on which the second gear member 36 is installed. Further, the second thin diameter section 118 is rotatably retained by a pair of third bearings 120, which are provided in the second hole 56. The third bearings 120 are fixed in the second hole 56 by means of a holding member 122 installed in the opening of the second hole 56.

The piston 16 is threaded onto the screw section 116 of the rotary shaft 112, and is freely displaceable in the axial direction (directions of the arrows X1, X2) under a rotary action of the rotary shaft 112. The outer circumferential surface of the piston 16 abuts against the inner circumferential surface of the cylinder tube 110 and is supported thereby. Further, a cylindrical piston rod 126 is secured to a projection 124, which protrudes toward the rod cover 114 (in the direction of the arrow X1) at one end of the piston 16.

An annular scraper 128 installed in an annular groove, and an annular rod packing 130 separated from the scraper 128 by a predetermined distance for maintaining air tightness of the cylinder tube 110, are provided on the inner circumferential surface of the rod cover 114. Dust or the like, which may adhere to the outer circumferential surface of the piston rod 126, is removed as a result of the scraper 128. A cap 132 is installed on the end of the piston rod 126 in order to close the piston rod 126.

The internal resistance value of the motor (i.e., a DC motor or a stepping motor) that serves as the driving section 12 is set within a range of about 2 to 20 times the rated torque of the driving section 12. In particular, the internal resistance value is set within a range of about 2 to 20 times the rated torque of the driving section 12, wherein 1 is subtracted from the total number of the first and second plates 78, 80, and a number is obtained, which is then multiplied by the internal resistance value.

The electric cylinder 10 according to the embodiment of the present invention is basically constructed as described above. Next, its operations, functions, and effects shall be explained.

Current is supplied from an unillustrated power source to the driving section 12, whereby the drive shaft 24 of the driving section 12 is driven and rotated. Accordingly, since the teeth 66, 102 of the third gear member 38 and the rotary housing 28 are meshed with each other, the driving force is transmitted to the rotary housing 28.

When the rotary housing 28 is rotated, the first plates 78, which engage with the grooves 70 of the installation hole 68, are integrally rotated therewith. In this situation, the first plates 78 are rotated along with the operation oil A that fills the installation hole 68. Therefore, the second plates 80, which are disposed adjacent to the first plates 78, are integrally rotated through action of the operation oil A. That is, the operation oil A, which fills the rotary housing 28, has a high viscosity. Therefore, when the rotary housing 28 and the first plates 78 are rotated at a high speed, the second plates 80 are integrally rotated therewith by means of viscous resistance.

In other words, when the rotary housing 28 and the first plates 78 are rotated under a driving action of the driving section 12, because the velocity of rotation is high, viscous resistance of the operation oil A is increased and the transmitted driving force has a low torque.

Accordingly, rotational force of the rotary housing 28 is transmitted to the second plates 80 through the operation oil A, which is contained within the installation hole 68. The inner shaft 32, which engages with the second plates 80 through the cutout grooves 76, is integrally driven and rotated. Therefore, a driving force of the driving section 12 is transmitted to the inner shaft 32 via the rotary housing 28. The driving force is transmitted to the second gear member 36 of the cylinder mechanism 18, which meshes with the first gear member 34 that is installed on the inner shaft 32, whereby the rotary shaft 112 of the cylinder mechanism 18 is rotated.

Accordingly, the piston 16, which is threadedly engaged with the rotary shaft 112, is displaced along the cylinder tube 110 in the axial direction (direction of the arrow X1 as shown in FIG. 2), due to the threaded engagement thereof. The piston rod 126 connected to the piston 16 protrudes a predetermined length with respect to the rod cover 114. As a result, a workpiece (not shown) that is attached to the cap 132 at the end of the piston rod 126 is displaced a predetermined length.

As described above, the driving force of the driving section 12 can be transmitted to the cylinder mechanism 18 via the gear unit 14 and the power transmission switching mechanism 20, whereby the piston rod 126 of the cylinder mechanism 18 is displaced by a predetermined amount.

On the other hand, when displacement of the piston rod 126 of the cylinder mechanism 18 is stopped, rotary driving of the driving section 12 is halted by terminating the supply of current to the driving section 12. In this situation, the drive shaft 24 of the driving section 12 is rotated a certain amount by inertial force, even after the supply of current to the driving section 12 has been terminated. However, the driving section 12 is rotated at a low velocity and with high torque. Therefore, rotation of the first plates 78, which accompanies rotation of the driving section 12, is absorbed by the operation oil A as well in relation to the power transmission switching mechanism 20. Thus, such rotation is not transmitted from the first plates 78 to the second plates 80.

Therefore, the inertial force of the driving section 12 is not transmitted to the inner shaft 32 via the operation oil A. The cylinder mechanism 18 can be stopped, without being affected by the inertial force of the driving section 12. In other words, when the first plates 78 are rotated at a low velocity, viscous resistance of the operation oil A is decreased. Therefore, the rotation of the first plates 78 is slipped by the operation oil A, and such rotation is not transmitted to the second plates 80.

By contrast, in certain situations, the unillustrated workpiece could be displaced a slight amount by inertial force, without being stopped after driving of the driving section 12 has been completely halted. In such a situation, when the inertial force (rotary driving force) transmitted to the rotary shaft 112 of the cylinder mechanism 18 is, in turn, transmitted to the inner shaft 32, the inertial force is absorbed by the operation oil A contained in the installation hole 68 through the second plates 80. Therefore, the inertial force generated by the cylinder mechanism 18 is not transmitted to the driving section 12 via the power transmission switching mechanism 20.

That is, when current is applied and the driving section 12 is driven and rotated at a high velocity, a driving force is transmitted to the cylinder mechanism 18 through the power transmission switching mechanism 20. Further, during low velocity rotation, in which driving and rotation are effected, for example, by an inertial force of the driving section 12, transmission of the driving force can be shut off or interrupted by allowing the driving force to be absorbed by the operation oil A of the power transmission switching mechanism 20. In other words, the power transmission switching mechanism 20 functions as a torque split mechanism, which shuts off transmission, whereby driving forces from the driving section 12 and/or the cylinder mechanism 18 are absorbed, as necessary.

As described above, in the embodiment of the present invention, the power transmission switching mechanism 20 is disposed between the driving section 12 and the cylinder mechanism 18. The power transmission switching mechanism 20 includes the rotary housing 28, which is filled with a high viscosity operation oil A, together with the plurality of first plates 78 and second plates 80, which are arranged inside the rotary housing 28. Accordingly, the driving force (inertial force) transmitted from the driving section 12 and the cylinder mechanism 18 can be appropriately absorbed by the operation oil A during periods in which the driving section 12 and the cylinder mechanism 18 are not driven, as compared with a conventional electric cylinder, in which a driving force is transmitted solely by a speed reducing mechanism from the driving source to the cylinder section. Therefore, when application of current to the driving section 12 is halted, transmission of the driving force to the driving section 12 and/or the cylinder mechanism 18 can be avoided. As a result, the driving section 12 and the cylinder mechanism 18 are not subjected to unnecessary loads, and hence, durability of the driving section 12 and the cylinder mechanism 18 can be enhanced.

Unnecessary driving forces are not transmitted between the driving section 12 and the cylinder mechanism 18. Accordingly, excessive loads are not generated on the teeth 66, 102, 106, 108 of the first to third gear members 34, 36, 38, which are connected to the driving section 12 and the cylinder mechanism 18. Therefore, the durability of the teeth 66, 102, 106, 108 can be enhanced. Accordingly, durability of the gear unit 14, including the first to third gear members 34, 36, 38, is improved.

When the first to third gear members 34, 36, 38 of the gear unit 14, the rotary housing 28, and the rotary shaft 112 of the cylinder mechanism 18 are formed, for example, from a resin material, a sintered metal, or a light metal material, then the gear unit 14 and the cylinder mechanism 18 can be reduced in weight, while reducing production costs as well.

Although certain preferred embodiments of the present invention have been shown and described in detail, it should be understood that various changes and modifications may be made therein without departing from the scope of the appended claims.

What is claimed is:

1. An electric cylinder comprising:
a driving section, which is driven under action of an applied current;
a speed reducing mechanism, which is connected to said driving section, and which transmits a driving force from said driving section while reducing a speed thereof;
a cylinder mechanism, to which said driving force is transmitted via said speed reducing mechanism, and which has a piston that is displaceable in an axial direction; and
a power transmission switching mechanism provided between said driving section and said cylinder mechanism, which transmits said driving force to said cylinder mechanism when said current is applied to said driving section, and which shuts off transmission of said driving force from at least one of said driving section and said cylinder mechanism when said current is not applied to said driving section.

2. The electric cylinder according to claim 1, wherein said power transmission switching mechanism further comprises:
a housing, which is driven and rotated under a driving action of said driving section;
a first rotary plate arranged in said housing and which is rotatable integrally while engaged with said housing;
a second rotary plate, which is separated a predetermined distance from said first rotary plate in said housing, and which is installed on a shaft connected to said cylinder mechanism; and
an operation oil hermetically enclosed in said housing, and which is charged in a space between said first and second rotary plates.

3. The electric cylinder according to claim 2, wherein said first rotary plate is rotated in accordance with rotation of said housing of said power transmission switching mechanism, so that a rotational force is transmitted to said second rotary plate by means of viscosity of said operation oil, whereby said shaft, to which said second rotary plate is installed, is rotated.

4. The electric cylinder according to claim 3, wherein a plurality of said first rotary plates and a plurality of said second rotary plates are provided respectively, said first rotary plates and said second rotary plates being alternately arranged along said shaft.

5. The electric cylinder according to claim 4, wherein said first rotary plate comprises a plurality of first projections, which protrude radially outwardly, wherein said first projections engage respectively with grooves formed on an inner circumferential surface of said housing.

6. The electric cylinder according to claim 5, wherein said first rotary plate comprises second projections, which protrude radially outwardly between said first projections, and wherein a clearance is provided between said second projections and an inner circumferential surface of said housing.

7. The electric cylinder according to claim 6, wherein said second rotary plate comprises a plurality of third projections, which protrude radially outwardly, and a hole having engaging sections that engage with said shaft, and wherein a clearance is provided between said third projections and said inner circumferential surface of said housing.

8. The electric cylinder according to claim 1, wherein said power transmission switching mechanism is disposed integrally with said speed reducing mechanism.

9. The electric cylinder according to claim 1, said operation oil comprising silicone oil, wherein a viscosity of said silicone oil is within a range of 10,000 to 100,000 cst.

10. The electric cylinder according to claim 1, said driving section comprising an electric motor, wherein an internal resistance value of said electric motor is within a range of 2 to 20 times a rated torque of said electric motor.
